(19) United States
(12) Patent Application Publication
(10) Pub. No.: US 2021/0292063 A1
(43) Pub. Date: Sep. 23, 2021

(54) Multiple Compartment Time Lockable Device, System, Software, and Mechanism

(71) Applicant: Alexander Igorevich Lednev, Glenmont, NY (US)

(72) Inventor: Alexander Igorevich Lednev, Glenmont, NY (US)

(73) Assignee: Alexander Igorevich Lednev

(21) Appl. No.: 17/207,752

(22) Filed: Mar. 22, 2021

Related U.S. Application Data
(60) Provisional application No. 62/993,053, filed on Mar. 22, 2020.

(51) Int. Cl. B65D 55/14; B65D 25/04; E05G 1/026; E05G 1/06; E05B 65/52; G07C 9/00

(52) U.S. Cl. CPC B65D 55/14; B65D 25/04; E05G 1/026; G07C 2009/0019; E05B 65/52; G07C 9/00182; E05G 1/06

(57) ABSTRACT

A system with multiple compartments each lockable until a user specified time and/or for a user specified duration.

### BACKGROUND OF THE INVENTION

### 1. Field of Invention

The present embodiments relate generally to the field of storage containers for the storage of items of an addictive nature. In particular, these items make sense to store until a configurable time in a configurable quantity. The present embodiments relate to food storage, nicotine storage, game cartridge storage, battery storage, money storage, password storage, or the storage of any goods that a user benefits from having limited access to.

### 2. Description of the Prior Art

It is clear that controlling one's own impulses is difficult, and curbing a habit can be even harder. It is also clear that many goods that people enjoy can be harmful in large quantities. This can be eating too many sweets, smoking too many cigarettes, consuming too many drinks, spending too much time on electronic devices, using too many recreational drugs, taking too many medical drugs, and so on. People often try to limit themselves by setting rules, but these rules are often hard to follow. A method of controlling the rate at which an object is accessed or used that cannot be subverted becomes a very useful tool.

Certain time lockable containers and other devices exist to address these problems; however they only have one lockable storage compartment, and are thus not suited to curbing a daily habit. For example, if a person locks away a whole package of cookies in one container, there is nothing stopping the person from eating the entire package as soon as the container is unlocked and the cookies are accessible. The same can be said of a pack of cigarettes, a bottle of medication, etc. A need therefore exists for a system of multiple time lockable containers in one device that can be filled and unlocked independently or together as necessary. Consider the example just described with the package of cookies. If only one cookie was placed in each time lockable compartment and only one compartment was unlocked each day, then there now exists a limit of one cookie per day for the user. On the other hand, if a whole package was placed, the user may lack the self-control to limit consumption to only one cookie and lock the remaining cookies back in the container.

Additionally, other devices are locked for a particular period of time, which will not work easily for repeated daily use. For example, if you wanted one compartment to open at 6 pm every day, you would need to do a lot of math to get each compartment timer correct. The proposed system uses a real time clock to control the unlocking of the compartments, making it very easy to set and maintain a schedule.

In addition, most storage devices are relatively cumbersome to program. The proposed system takes advantage of multiple buttons combined with smart software in the device and/or remote control via a Bluetooth, Wi-Fi, or another communication protocol to allow the user to easily program the device remotely from another device including, but not limited to, a mobile phone, tablet, or computer. The proposed system also has methods of programming all compartments at once by inferring patterns in the user's input.

The following application seeks to solve the stated problems.

### SUMMARY OF THE INVENTION

Illustrative embodiments of the present invention shown in the attached drawings are more fully described in the Detailed Description section. It is understood that the invention is not limited to the forms described in this Summary of Invention or in the Detailed Description. A person well read on the subject can recognize that there are many other manifestations that fall within the spirit and scope of the invention expressed in these claims.

The present application provides a multiple compartment time-lockable storage system for storing items until a user configurable time.

In one illustrative embodiment two or more compartments are formed from the divisions of a cylinder. A center piece of the device houses the locking mechanism and the electronics. A rotating structure is moved by the user and allows access to one compartment at a time. Buttons and an LCD screen are present in the center piece to allow the user to configure the device. There are individual buttons for the numbers 1, 2, 3, 4, 5, 6, 7, 8, 9, and 0 to allow the user to easily select a time. There are also additional buttons that serve different functions depending on the state of the device.

In another embodiment, the user can access multiple compartments at one time.

In another embodiment part of the structure is removable to allow access to all compartments for easy deposition of items into all compartments.

In another embodiment part of the structure is removable to enable easy cleaning of the device either by hand, hand tools, or dishwasher.

In another embodiment the top structure is foldable to allow access to compartments via hinges.

In another embodiment the top structure slides to allow access to compartments.

In another embodiment locking mechanisms exist for each individual compartment, allowing access to each compartment individually.

In another embodiment, the device is connected to a controlling device via Bluetooth, Wi-Fi, or another connection technology so that the device can be controlled remotely. The controlling device may have an application to make it easier to program the device and execute more complex functions. This application can have the ability to send notifications to the user to let them know about the status of the compartments or the device in general. This includes, but is not limited to, information about compartments locking, compartments unlocking, time milestones, user milestones, low battery, battery charging, battery charged, achievements, and any other information the user may find useful.

In another embodiment, machine learning is used to infer the user desired programming of the device, allowing for faster programming with less user input.

In another embodiment, the device will have user profiles to allow users to save their preferred settings. These user profiles may also be used to allow the software algorithms to better predict user inputs.

In another embodiment the LCD screen will feature a countdown timer to the opening time of each individual compartment.

In another embodiment the LCD screen will feature one countdown timer to the opening time of each individual compartment. The user can cycle through the compartments or use individual buttons to select which countdown timer is shown.

In another embodiment the LCD screen will feature the real time opening time of each individual compartment. This can include one or more of the following: 12 hour time, 24 hour time, am, pm, day of the week, date, month, and year.

In another embodiment the LCD screen will feature one real time opening time of each individual compartment. The user can cycle through the compartments or use individual buttons to select which countdown timer is shown. This can include one or more of the following: 12 hour time, 24 hour time, am, pm, day of the week, date, month, and year.

In another embodiment the LCD screen can display one or more of the following: current time, date, and day of the week.

In another embodiment each compartment will have one or more LEDs or other light sources associated with it to communicate with the user. This light source can be mounted anywhere on the device, including but not limited to, in a pattern matching the individual compartments, near the LCD display, under any buttons, and on the sides of the container.

In another embodiment the device is powered via rechargeable batteries, and can be charged from a wall outlet, USB port, or any other power source.

In another embodiment the device is powered directly from a wall outlet or other power source.

In another embodiment the compartments have more than one access port to allow for access when placed on the side or when laid flat.

In another embodiment, a master key can be used to open any of the compartments at any time. This can be used to change the contents of the compartments. This would most likely be used by someone other than the main user of the device.

In another embodiment a user can enter a master pin or password into the device or into the remote control unit or application to open any compartment at any time. The user can also reprogram the opening times of the compartments and adjust other settings. There may also be limitations with certain settings not able to be changed or certain settings not able to be changed to certain values.

In another embodiment the application itself can be used as the storage location. This can be used to store electronic codes including, but not limited to, passwords, usernames, and activation codes. In this way the user can limit access to certain websites or other services or devices.

In another embodiment the electronic password storage is paired with a device with one or more compartments secured with a passcode lock. The required passcode can be changed by the application, the user, or another user. This passcode is only presented to the user at the user or other user set time.

In another embodiment the device is constructed such that it cannot be disassembled while one or more compartments are in a locked state.

In another embodiment the device is constructed such that it can never be disassembled.

In another embodiment hand holds are placed at the bottom of the device to allow the device to be picked up and held more easily.

In another embodiment an RFID key is used as the master key to open any compartments.

In another embodiment the device is made dishwasher safe for easy cleaning.

In another embodiment the device is able to form an airtight seal of the compartments.

In another embodiment the compartments are reconfigurable to form different numbers, different sizes, and different shaped compartments.

In another embodiment a bearing is used to rotate the physical enclosing mechanism 101.

### BRIEF DESCRIPTION OF THE DRAWINGS

FIGS. 1A-B illustrate various views of the compartment portion of the multiple compartment time lockable device.

FIGS. 2A-B illustrate various views of the physical enclosing mechanism portion of the multiple compartment time lockable device.

FIG. 3 illustrates a views of the battery cover portion of the multiple compartment time lockable device.

FIGS. 4A-B illustrate various views of the electronics and locking mechanism enclosure portion of the multiple compartment time lockable device.

FIGS. 5A-B illustrate various views of the control enclosure top cover portion of the multiple compartment time lockable device.

FIG. 6 illustrates a view of the silicone button structure portion of the multiple compartment time lockable device.

FIGS. 7A-B illustrate various views of the printed circuit board portion of the multiple compartment time lockable device.

FIG. 8 illustrates a view of the potentiometer gear portion of the multiple compartment time lockable device.

### DETAILED DESCRIPTION OF THE PREFERRED EMBODIMENT

The current application and embodiments relate to a real time lockable storage device, system, and software.

It should be understood that real time lockable refers to a system that is locked until a user set time wherein the set time may be any predetermined time (e.g. 6:00 pm on Monday). This does not preclude other mechanisms from overriding one or more locking mechanisms as discussed in the Summary of the Invention.

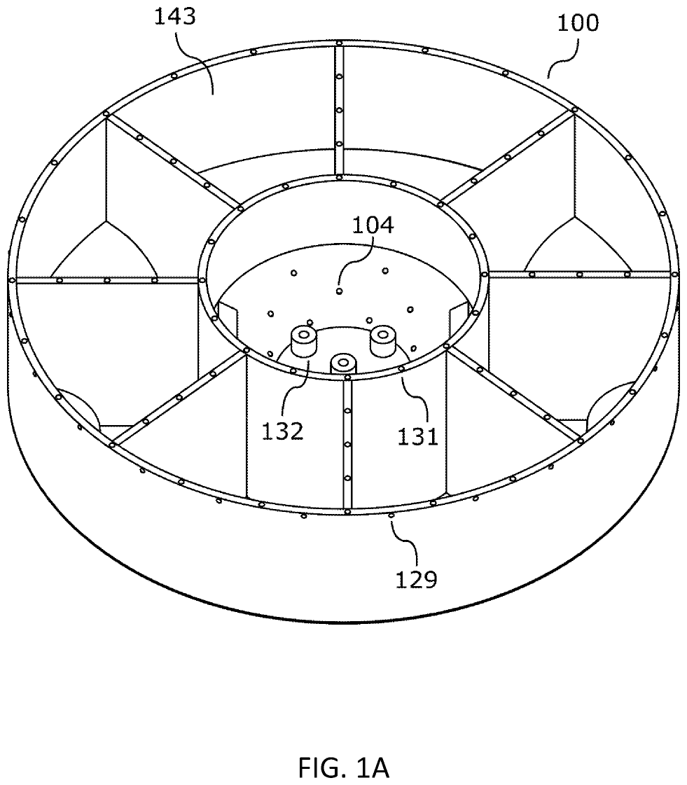

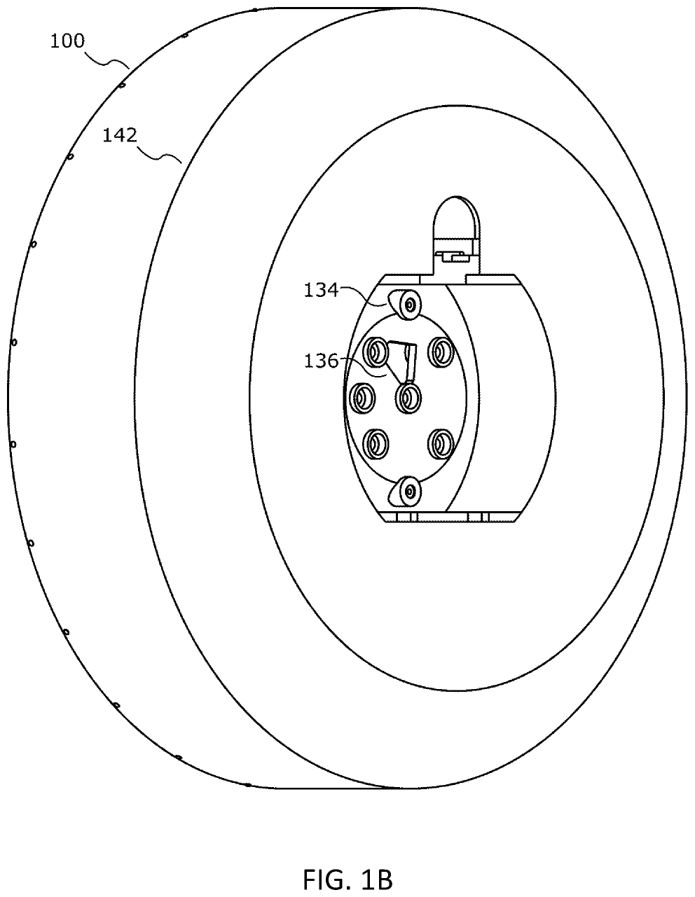

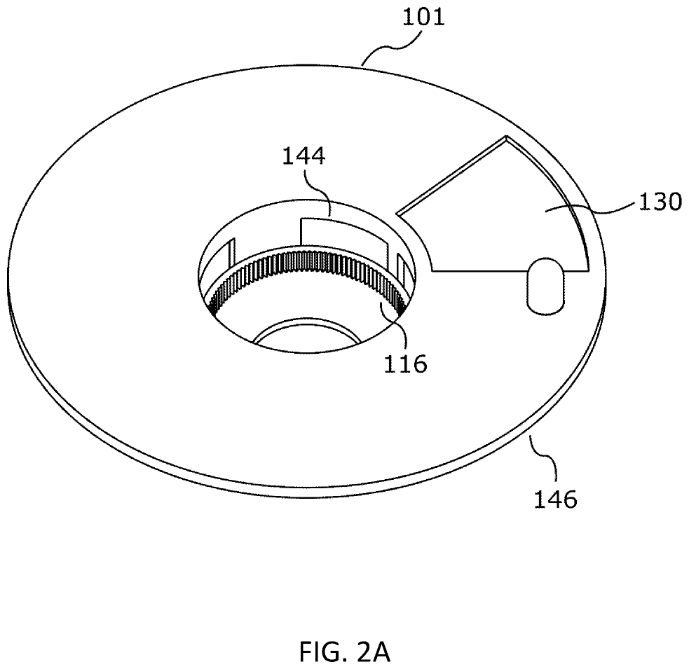

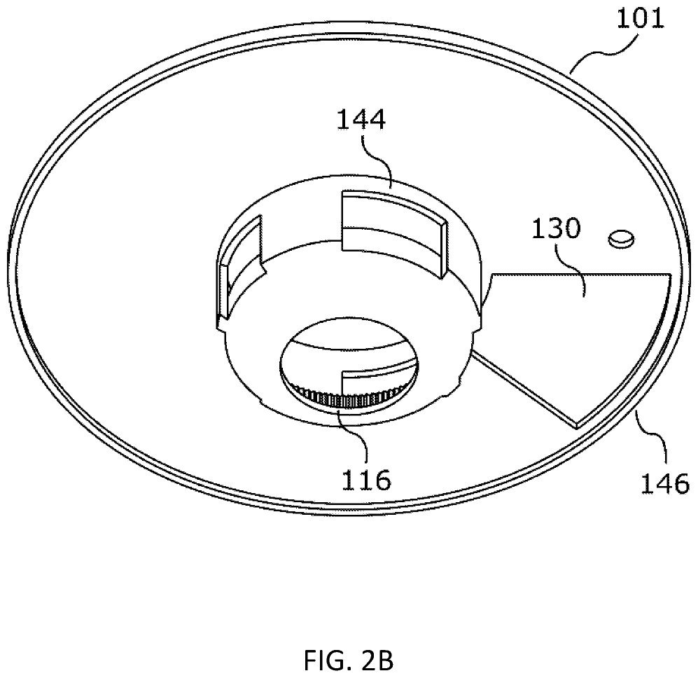

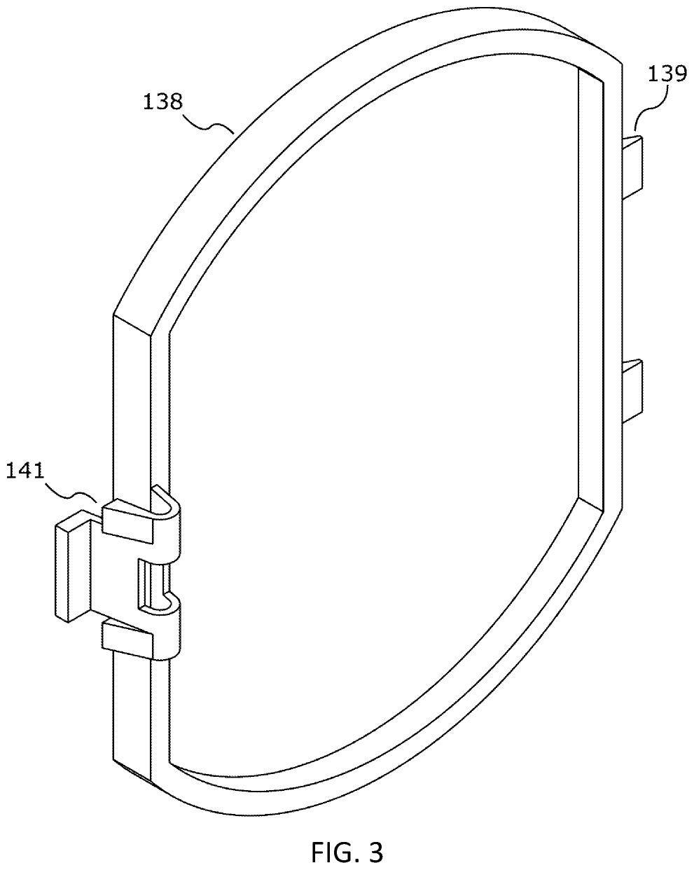

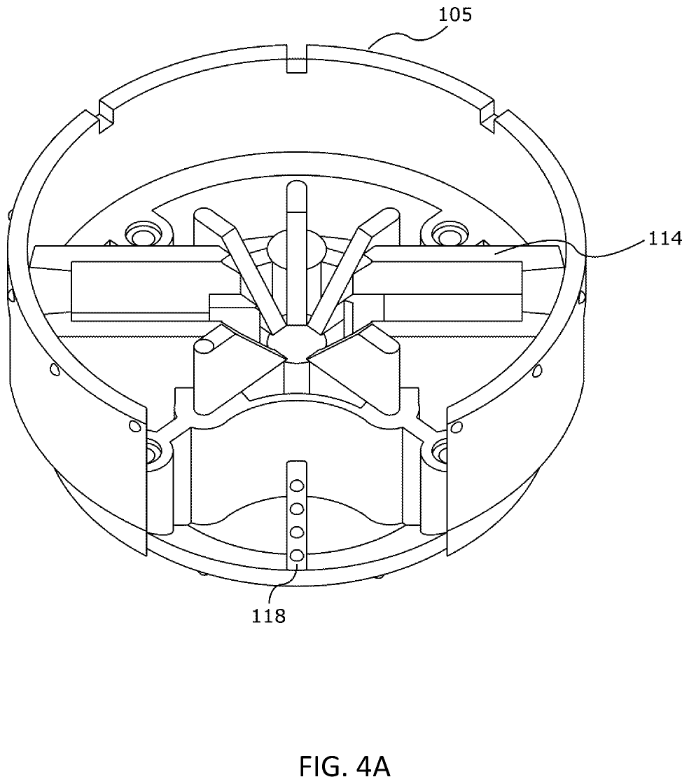

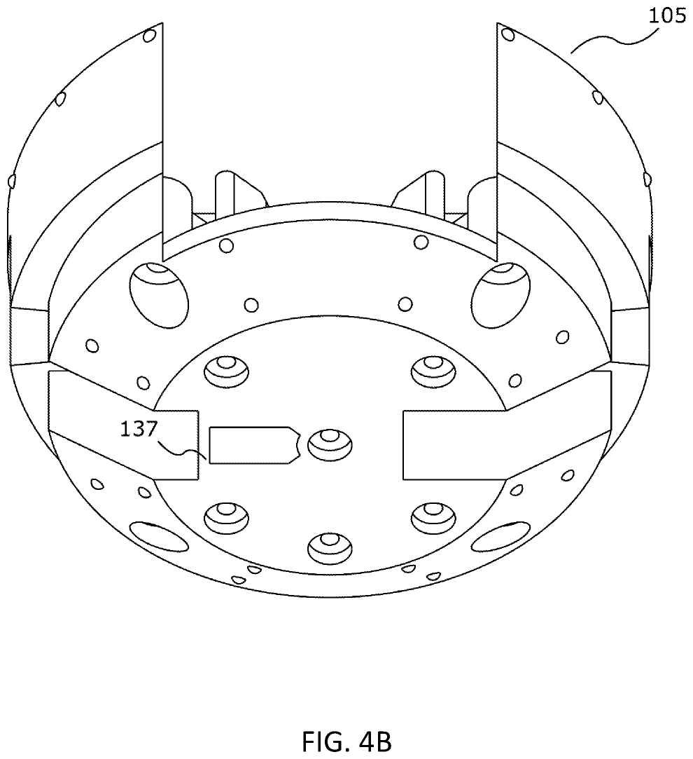

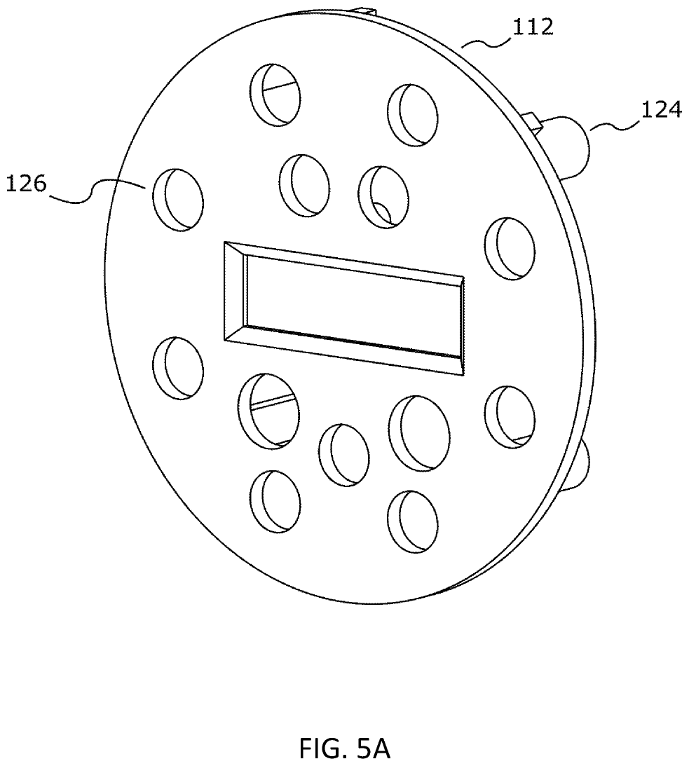

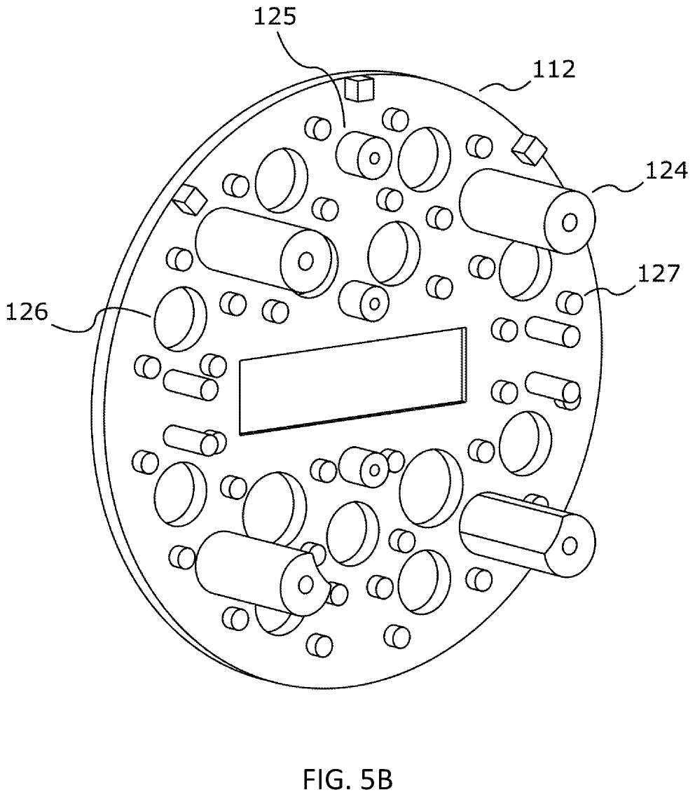

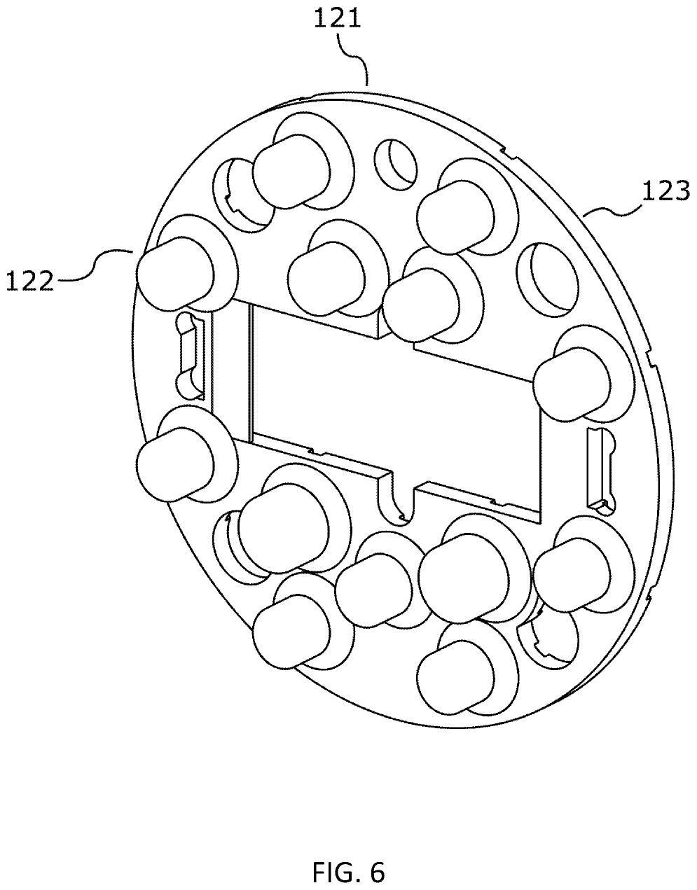

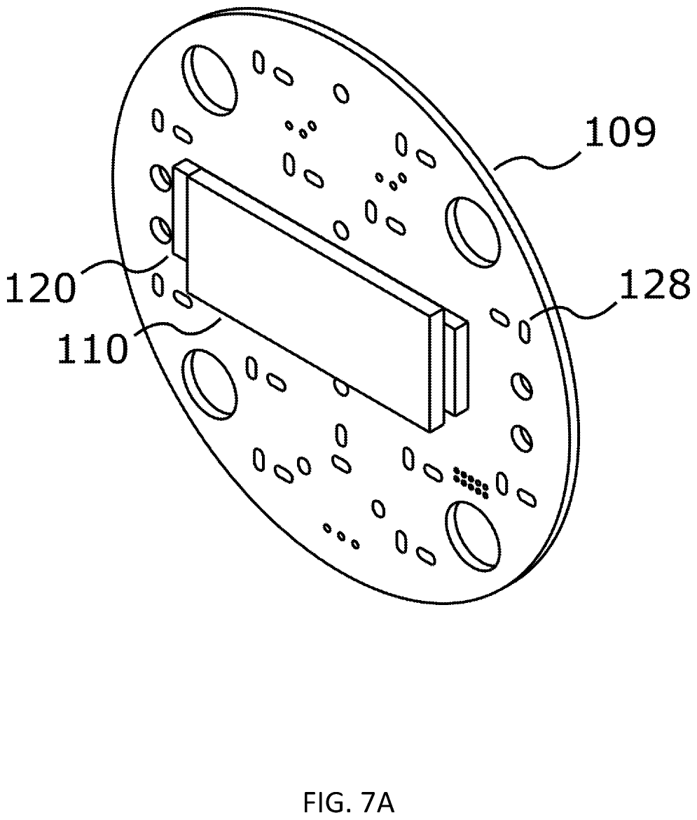

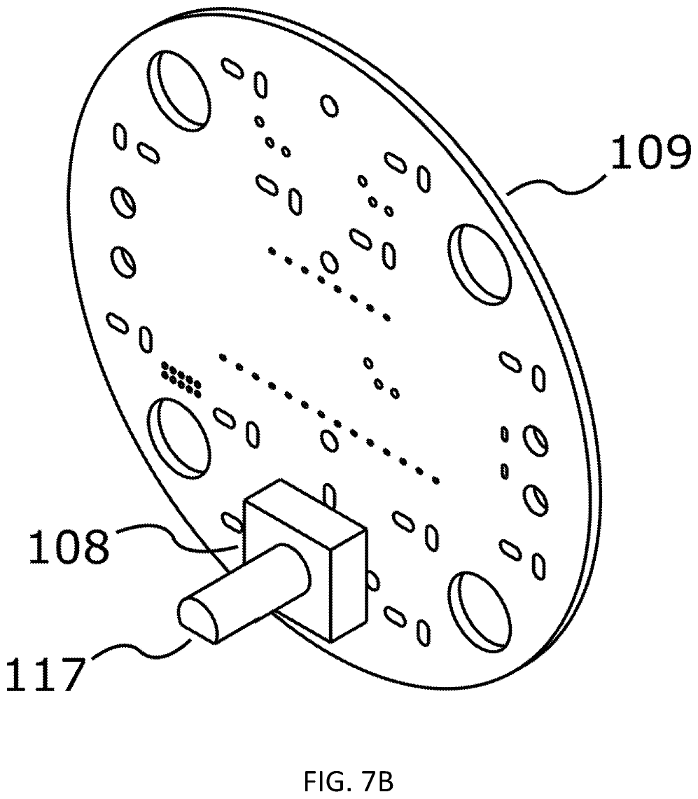

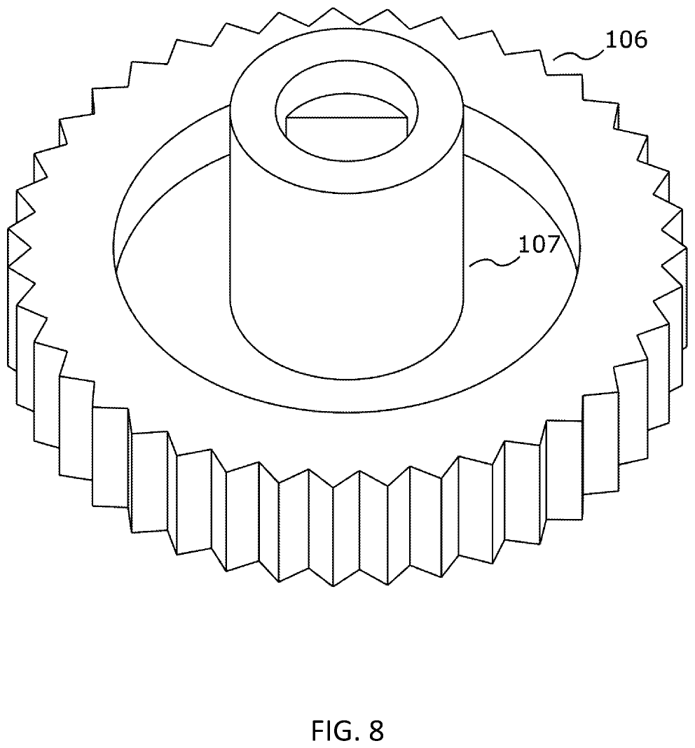

In one embodiment illustrated in FIGS. 1-5, the time lockable container is separated into 3 major components: the compartments 100, the physical enclosing mechanism 101, and the electronics and locking mechanism enclosure whose outer portion is made out of the control enclosure top cover 112 and the outer control enclosure shell 105.

The compartments 100 may be comprised of two or more separate compartments 143, each individually accessible by the user.

The physical enclosing mechanism 101 is able to rotate above the compartments 100 to allow access to one compartment at a time via an opening 130 in the physical enclosing mechanism 101. The rotation is facilitated and kept smooth by the use of many low friction semi-spherical contact points 104. The physical enclosing mechanism 101 is held in place in between the compartments 100 and the outer control enclosure shell 105 through the use of the low friction semi-spherical contact points 104. The semi-spherical contact points 104 exist between the physical enclosing mechanism 101 and both the compartments 100 and the outer control enclosure shell 105.

The electronics and locking mechanism enclosure is fully made up of the outer control enclosure shell 105, the separate gear 106 with gear shaft 107, rotary encoder 108, main control printed circuit board (PCB) 109, LCD display 110, silicone button structure 121, control enclosure top cover 112, PCB screws, solenoids 114, and control enclosure top cover to outer shell screws.

The physical enclosing mechanism 101 forms an interface with the electronics and locking mechanism enclosure 102 that enables the device electronics and software systems to learn the angular position of the physical enclosing mechanism 101. In this preferred embodiment, this is done with a mating set of gears. One gear 116 is built into the physical enclosing mechanism 101, while the other gear 106 is separate and attaches to a rotary encoder 108 via the rotary encoder shaft 117 and the shaft 107 leading off the separate gear 106. The gear 106 rotates on low friction semi-spherical contact points 118 similar to the semi-spherical contact points 104. The rotary encoder 108 is attached directly to the bottom of the main control PCB 109.

The main control PCB 109 is attached to the control enclosure top cover 112 with three PCB screws. An LCD backlight 120 is attached to the top of the main control PCB 109. An LCD display 110 is attached to the top of the main control PCB 109 on top of the LCD backlight 120. The LCD display 110 forms a seal with the control enclosure top cover 112 when the main control PCB 109 is attached to the control enclosure top cover 112. A silicone structure 121 that forms the silicone buttons 122 and main silicone structure 123 rests on the top of the main control PCB 109. It is held in place by the four screw shafts 124 between the control enclosure top cover 112 and the outer control enclosure shell 105, the three screw shafts 125 between the control enclosure top cover 112 and the main control PCB 109, the silicone button holes 126 in the control enclosure top cover, the LCD backlight 120, the LCD display 110, and the silicone pad positioning structures 127.

The silicone buttons 122 form 10 buttons for each digit from 0 to 9, making it very easy to input time and to select compartments 143. A software algorithm easily extrapolates the unlocking time to all available compartments 143. This algorithm relies on the user first inputting the unlock time using the silicone buttons 122 for one or more compartments 143, and then automatically making a best guess for the unlocking times of the other compartments 143. The user can view these results by pressing the button corresponding to the individual compartment 143 they are interested in and edit the times until satisfied with the results. The user then locks all compartments 143, or just the compartments 143 the user selects using the silicone buttons 122. In addition to the 10 buttons for each digit from 0 to 9, there are also functional buttons that serve different purposes depending on the state of the device.

LED lights 128 are mounted on the underside of the main control PCB 109. Holes in the main control PCB 109 allow the LED light to project up under the silicone buttons 122. The silicon buttons 122 are formed from translucent silicone to allow the light of the LEDs 128 to project up through the silicone buttons 122 so that the user can see the light. This light can be used to signal lots of useful information, including but not limited to, compartment selection, compartment unlocking, compartment locking, low battery, status indicators, and system settings. The LEDs 128 may be different colors or multi-color LEDs.

The physical enclosing mechanism 101 has edges 146 which hang over the sides of the compartments 100 to prevent prying up. In between the edges 146 and the compartments 100 are another set of low friction semi-spherical contact points 129 to reduce friction and ensure correct positioning. More low friction semi-spherical contact points 131 keep the physical enclosing mechanism gliding above the compartments 100.

To correctly position the physical enclosing mechanism 101 between the compartments 100 and the outer control enclosure shell 105, standoffs 132 are used. Through these six standoffs 132, screws 133 are inserted to firmly join the compartments 100 and the outer control enclosure shell 105.

More mounting holes 134 are present on the bottom of the compartments and used to mount a battery holder 135. To connect the battery holder 135 to the main control PCB 109, a hole 136 is made in the compartments 100. A hole 137 is also made in the outer control enclosure shell 105. This allows for easy assembling of the device.

The battery holder 135 is positioned to restrict access to the screws 133 holding the compartments 100 together with the outer control enclosure shell 105.

A battery cover 138 is used to cover up the battery holder 135 during normal use. This battery cover 138 has two extrusions 139 which slide into two holes 140 in the compartments 100. This battery cover also has a bendable locking mechanism 141 that interacts with the compartments 100 to lock the battery cover 138 in place during normal use. The bendable locking mechanism 141 allows access to the battery holder 135 when necessary.

A groove 142 is made around the base of the compartments 100 to allow easy picking up of the device when it is on a flat surface such as a table. This groove 142 also makes the device easier to hold.

In some embodiments one or more extrusions from the device allow the device to increase stability when the device is placed on its side. These extrusions can be placed so that the display is oriented in a manner easy for the user to read. The extrusions can also make it possible for the physical enclosing mechanism 101 to rotate while the device is on its side.

In some embodiments the memory used to store compartment opening times is preserved during power fail. Therefore the system returns to its previous state when power is restored.

The one or more solenoids 114 control rotation of the physical enclosing mechanism 101 and thus access to any individual compartment or compartments 143. This is done by the design of slots 144 in the physical enclosing mechanism 101 that align with the solenoids 114. This design of the slots 144 allows for independent control of rotation directions using the solenoids 114. Rotation can be enabled in one direction, the other direction, or both directions by engaging one or more solenoids 114. When the solenoids 114 are in their extended state, they prevent rotation in one or more directions due to contact with the slots 144.

When the solenoids 114 are unpowered, they attempt to resume their extended state. This means that during a power fail, the compartments are automatically locked.

The unique, particular pattern of slots 144 allows the entire system to be controlled with a minimum number of actuators. In this particular embodiment, two solenoids 114 are used. One solenoid prevents rotation clockwise and one solenoid prevents rotation counterclockwise. In this way, the system can allow rotation in only one direction, providing access only to a specific compartment 143.

As mentioned above, in some embodiments this device can be connected to others by way of radio waves, Wi-Fi, Bluetooth, or other communication mechanisms. This allows for advanced modes and controls as mentioned above.

Several embodiments have been described herein that are exemplary of the invention. One skilled in the art will recognize additional embodiments within the scope and spirit of the present invention.

What is claimed is:

1. A device with two or more time locking compartments that can be locked until user set times.

2. An embodiment of claim 1 with wireless communication functionality that can receive input from a wireless transmitting device.

3. An embodiment of claim 1 further comprising a port for an external power supply.

4. An embodiment of claim 1 further comprising a controller that uses an algorithm to predict user desired unlocking times for individual compartments.

5. An embodiment of claim 1 wherein a rotating piece of the device allows access to one compartment at a time.

6. An embodiment of claim 5 wherein an enclosure exists in the center of the device further comprising a locking mechanism.

7. An embodiment of claim 5 wherein an enclosure exists in the center of the device further comprising buttons or actuators the used by the user to interface with the device.

8. An embodiment of claim 5 wherein an enclosure exists in the center of the device further comprising a display.

9. An embodiment of claim 5 wherein an enclosure exists in the center of the device further comprising a timing device.

10. An embodiment of claim 5 wherein an enclosure exists in the center of the device further comprising control board and electronics.

11. An embodiment of claim 5 wherein an enclosure exists in the center of the device further comprising a battery.

12. A rotational motion control mechanism that uses the interaction of a series of one or more slots and one or more actuators to prevent and/or enable rotation.

13. An embodiment of claim 12 wherein rotation can be prevented and/or enabled in one direction or both directions at the same time.
